(19) United States
(12) Patent Application Publication
(10) Pub. No.: US 2026/0084467 A1
(43) Pub. Date: Mar. 26, 2026

(54) TREAD BLOCK ARRANGEMENT HAVING A SIPE, AND A LAMELLA PLATE

(71) Applicant: Nokian Renkaat Oyj, Nokia (FI)

(72) Inventors: Jorma TIKKA, Nokia (FI); Mikko JOKINEN, Nokia (FI); Tomi KORKAMA, Nokia (FI)

(21) Appl. No.: 19/328,314

(22) Filed: Sep. 15, 2025

(30) Foreign Application Priority Data
Sep. 23, 2024 (EP) 24202004.8

(51) Int. Cl. B60C 11/03; B60C 11/12

(52) U.S. Cl. CPC B60C 11/0306; B60C 11/1259; B60C 11/1272; B60C 2011/1213; B60C 2011/1268

(57) ABSTRACT

A tread block arrangement suitable for a tyre or for a tread band for a tyre, the tread block arrangement comprising a having a first sipe. A bottom of the first sipe is provided with at least a first recess and a second recess, the first recess and the second recess intruding the tread block from the bottom line away from a top opening of the first sipe. The first and second recesses are comprised by first and second sipe expansions, respectively. The sipe expansions extend towards the top opening of the first sipe and locally widen the first sipe. A lamella plate for producing the first sipe.

This application claims benefit from European patent application EP24202004 filed on the 23 Sep. 2024.

### TECHNICAL FIELD

The present invention relates to a tyre or a tread band having tread blocks, and being provided in the tread blocks with sipes, more particularly to an improved sipe structure or sipe arrangement of a tread block. The present invention also relates to lamella plates that are used in the manufacturing process of a pneumatic tyre for making said sipe structure or sipe arrangement.

### BACKGROUND

A pneumatic tyre 100 is indicated in FIG. 1a. The pneumatic tyre 100 is known to include a tread 110 which has circumferential and transversal grooves 120 on its outer surface, said grooves 120 defining a number of protruding parts, such as ribs and tread blocks 210. The tread 110 is meant for a rolling contact against a ground surface 900, such as road. The grooves 120 are meant for draining water and/or slush that is possibly located on the ground surface away from the tread, so that the contact between the tread 110 and the ground surface 900 is as good and consistent as possible. A tread 110 of the tyre 100 can be formed by applying a tread band 150 onto a body of a tyre as depicted in FIG. 1b.

Referring to FIG. 2a, certain types of tyres such as winter tyres and all season tyres are provided in the tread with a number of sipes 500 at various angles with respect to a motion direction of the tyre. The sipes 500 serve a better tyre-ground contact by providing more gripping edges, and particularly in rain by trapping water or on snow by trapping slush/snow, thereby improving traction, braking and lateral stability. The sipes 500 also make the rubber material to deform more easily, in effect making the tyre appear softer. This also improves friction. Sipes improve traction and braking of worn tyres, particularly of tyres that are near the end of their service life because of wearing. Sipes 500 are formed during manufacturing a tyre 100, e.g. by inserting a lamella plate 300, such as one of FIG. 2b, to a green tyre, and after curing the tyre, removing the lamella plate 300 from the tyre 100.

A known lamella plate 300 may have a constant thickness as shown in FIG. 2b. Moreover, a bottom edge 314 of a known lamella plate 300 may be configured to form a sipe having a substantially even bottom, as readable from FIG. 2b. Thus, when the tyre wears by an amount corresponding to a depth of the sipes 500, no sipes are left in the tread, as shown in FIG. 2c.

The inventors have found that having such sipes worsen the handling and traction of a worn tyre. Namely, as the tyre wears, the sipes becomes shallower, which may prevent proper function of the sipes even if the sipes are not totally worn out. Naturally, when the tyre has worn by such an amount that no sipes are left (as in FIG. 2c), the properties of the tread are not affected by sipes since there are not any.

The inventors have considered to deepen the sipes. However, it was realized that deepening the whole sipes effectively softens the tread material too much thereby reducing the handling and traction properties of the tyre.

In line with these findings there is a need to improve handling and traction properties of a worn tyre.

### SUMMARY

The inventors have found that if the bottom of the sipe is provided with indentations, even if the main part of the sipe wears out, the indentations still remain in the tread thereby improving the tyre performance even if the tyre has worn. Moreover, because of forming indentations to the bottom of the sipe instead of deepening the whole sipe, the tyre performance of an unworn or partially worn tyre is also good. Furthermore, particularly grip on wet surface can be improved by providing the sipe with a widening portion so that the widening portion can receive water and/or slush from a wet road thereby improving the grip between other parts of the tread and the road.

### BRIEF DESCRIPTION OF THE DRAWINGS

FIG. 1a shows a tyre in a perspective view,

FIG. 1b shows application of a tread band onto a body of a tyre,

FIG. 2a shows sipes of a unworn known tyre,

FIG. 2b shows a known lamella plate,

FIG. 2c shows a worn known tyre, wherein the tread has worn so much that no sipes are present,

FIG. 3a shows an embodiment of a sipe in a side view,

FIG. 3b shows a cross section of embodiment of a sipe,

FIG. 3c shows a cross section of embodiment of a sipe,

FIG. 4a shows an embodiment of a lamella plate in perspective view, the lamella plate being for the purpose of producing a sipe of the kind shown in FIGS. 3a to 3c,

FIG. 4b shows a cross section of the lamella plate of FIG. 4a,

FIG. 4c shows a cross section of the lamella plate of FIG. 4a,

FIG. 4d shows a side view of the lamella plate of FIG. 4a,

FIG. 5 shows an embodiment of a lamella plate in perspective view,

FIG. 6 shows a worn tyre according to an embodiment, wherein the tread has worn so much that only recessions of sipes are present,

FIG. 7a shows in its upper part a top view of sipes and in its lower part a side view of one of the sipes,

FIG. 7b shows in its upper part a top view of sipes and in its lower part a side view of one of the sipes,

FIG. 7c shows in its upper part a top view of sipes and in its lower part a side view of one of the sipes,

FIG. 8a shows a cross section of an embodiment of a sipe,

FIG. 8b shows a cross section of an embodiment of a sipe,

FIG. 8c shows an embodiment of a sipe in a side view,

FIGS. 9a to 9c show patterns of sipes manufactured by the lamella plate of FIG. 10a,

FIG. 10a shows an embodiment of a lamella plate in a perspective view,

FIG. 10b shows a cross section of an embodiment of a lamella plate, and

FIG. 11 shows an embodiment of a lamella plate in perspective view.

### DETAILED DESCRIPTION

In this description at least the following terms are used:

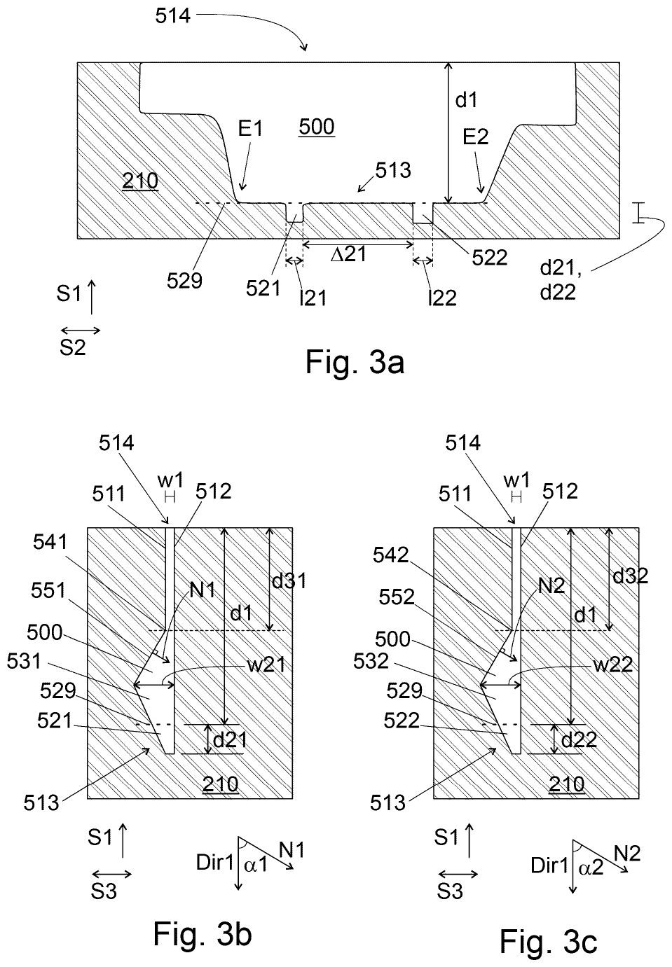

A sipe refers to a narrow groove provided in a tread block of a tyre. A primary width w1 of a sipe may be e.g. 0.2 mm to 1 mm, such as 0.2 mm to 0.7 mm. An example of the primary width w1 is shown in FIG. 3b.

A lamella plate refers to a plate that is usable for forming a sipe in a moulding process. Thus, when a lamella plate is embedded to uncured rubber, and removed therefrom after curing the rubber, the shape of the sipe formed by the lamella plate is geometrically congruent with the lamella plate. The rubber from which the lamella plate is removed may be rubber material of a tyre or rubber material of a tread band.

A lamella refers to a part of rubber arranged in between two adjacent sipes.

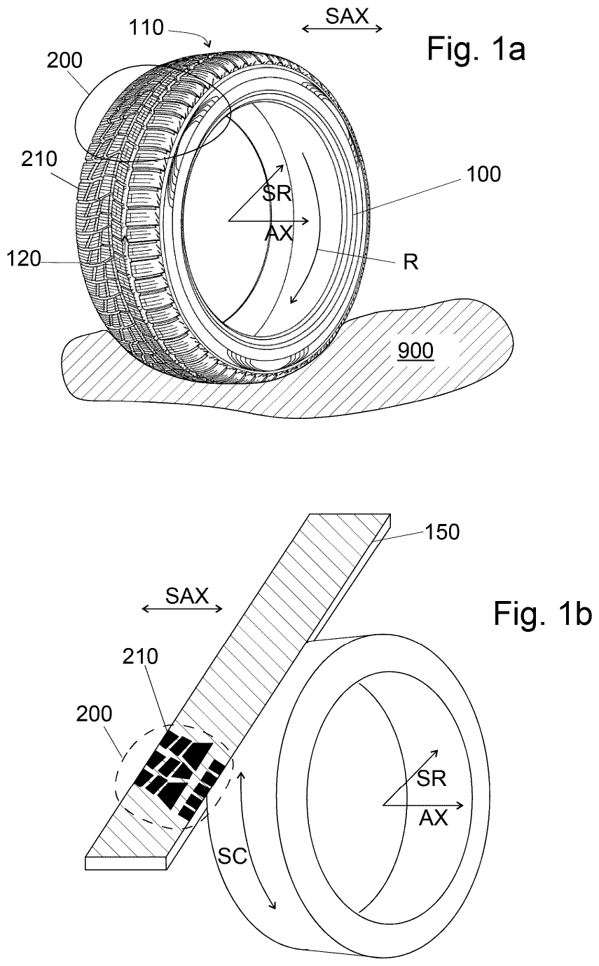

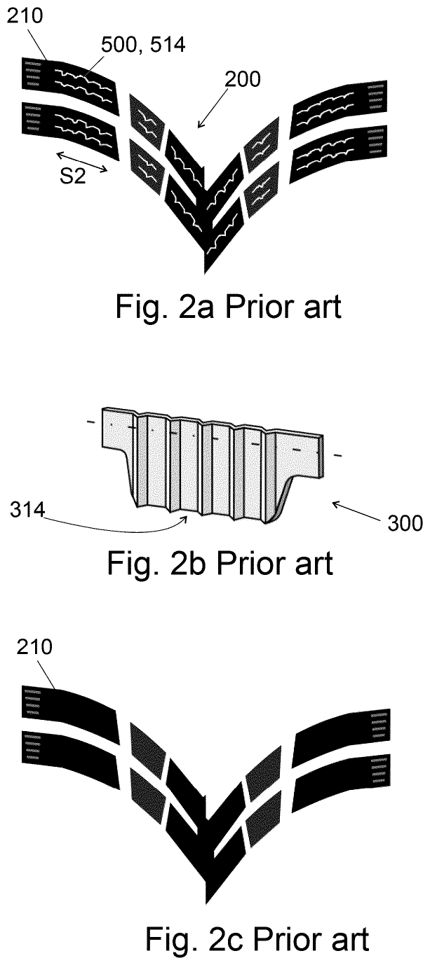

Referring to FIG. 1a, as is well known, a tyre 100 comprises a tread 110. The tread is formed of multiple tread blocks 210, which in combination form a tread block arrangement 200. Referring to FIG. 2a, each tread block 210 may comprise a number of sipes 500. Even if FIGS. 1a and 2a are showing prior art, these terms and principles apply to the present invention, too. The present invention concerns a shape of a sipe 500, and a lamella plate for forming such a sipe. FIG. 3a and figures subsequent thereto explain embodiments.

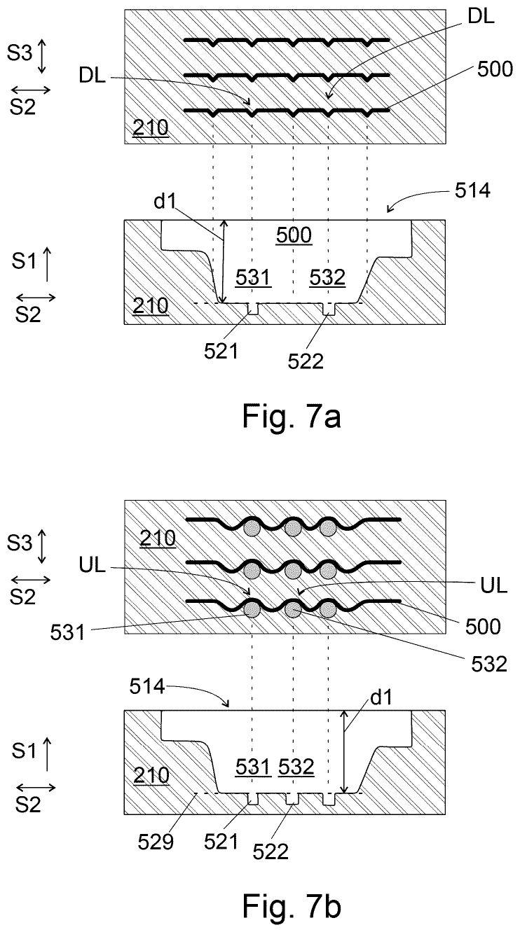

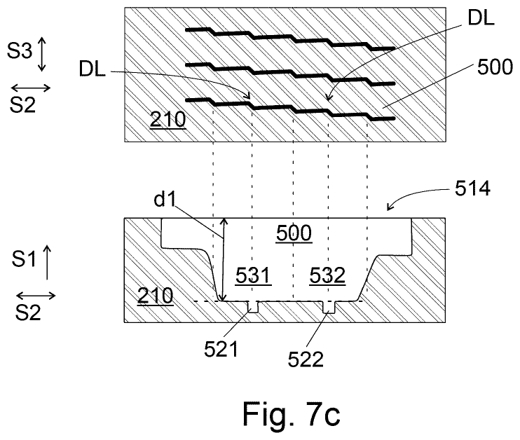

Referring to FIG. 3a, a sipe 500, which is delimited by the tread block 210, has a top opening 514, which is visible on the tread. Namely, the part of the sipe 500 shown e.g. in FIG. 2a is just the top opening 514 of the sipe 500. The shape of the sipe 500 beneath the tread surface is generally not visible to naked eye. Further examples of top openings 514, as seen from top, are shown in FIGS. 7a to 7c.

The bottom 513 of the sipe 500 defines a bottom line 529 of the sipe 500. The bottom line 529 may be substantially straight. However, the bottom 513 of the first sipe 500 is provided with at least a first recess 521 and a second recess 522, which intrude the tread block 210. In FIG. 3a, the direction S1 is a direction of depth of the sipe 500 and this direction S1 typically is the radial direction SR of the tyre directed away from the axis of rotation of the tyre (see also FIG. 1a). However, the direction S1 may be tilted relative to SR according to needs. In FIG. 3a, the direction S2 is a direction of length of the sipe 500.

This direction S2 typically is more or less aligned with a direction of length of the tread block comprising the sipe, which direction of length typically is not circumferential. Reference is made to FIG. 2a for the direction S2. A direction S3 defines is the direction in which a width of the sipe is measured.

FIGS. 3b and 3c show a cross section of the sipe 500 at locations of the first recess 521 and the second recess, respectively. The direction S3 is perpendicular to both the direction S1 and the direction S2. A primary width w1 of the sipe 500 is measurable in the direction S3, as shown in these figures.

Referring to FIGS. 3b and 3c, the sipe 500 is arranged between two sipe walls (511, 512), the sipe walls being comprised by the tread block 210. These sipe walls are called a first sipe wall 511 and second sipe wall 512. The tread block 210 also forms the bottom 513 of the sipe 500.

The recesses 521, 522 have the effect that they improve handling of a worn tyre without degrading handling of a new tyre. Moreover, the first and second recesses 521, 522 are, respectively, comprised by a first and a second sipe expansion 531, 532. The sipe expansions 531, 532 make the sipe 500 locally wider in the direction S3 in order to receive more water and/or slush and/or snow from the surface 900 when the tyre is used. The purpose of the sipe expansion 531, 532 is therefore to improve traction on wet and/or snowy road.

To summarize, the embodiments relate to tread block arrangement 200. The tread block arrangement 200 is suitable for a tyre 100 or for a tread band 150 for a tyre 100. The tread block arrangement 200 comprises a tread block 210. The tread block 210 comprises at least a first sipe 500.

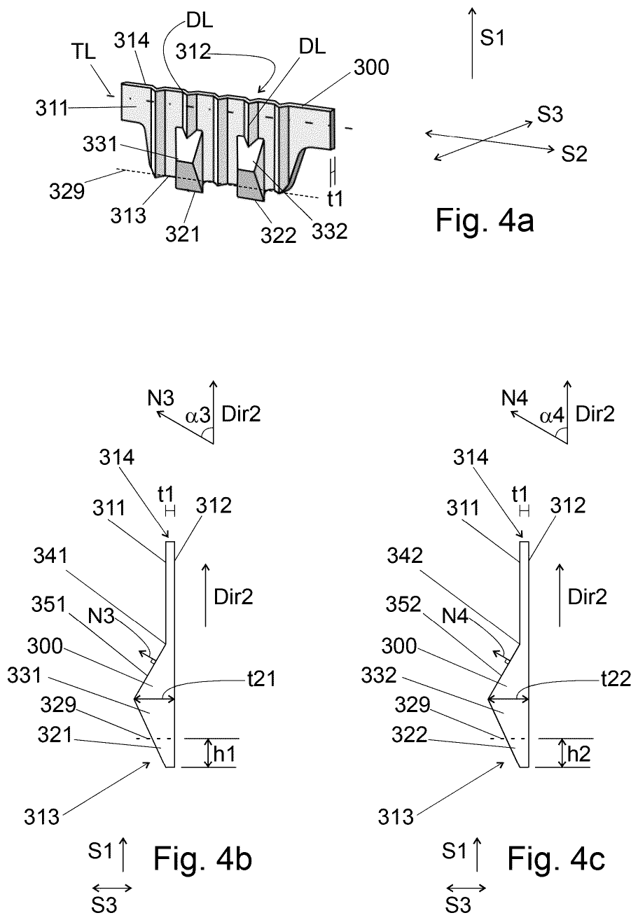

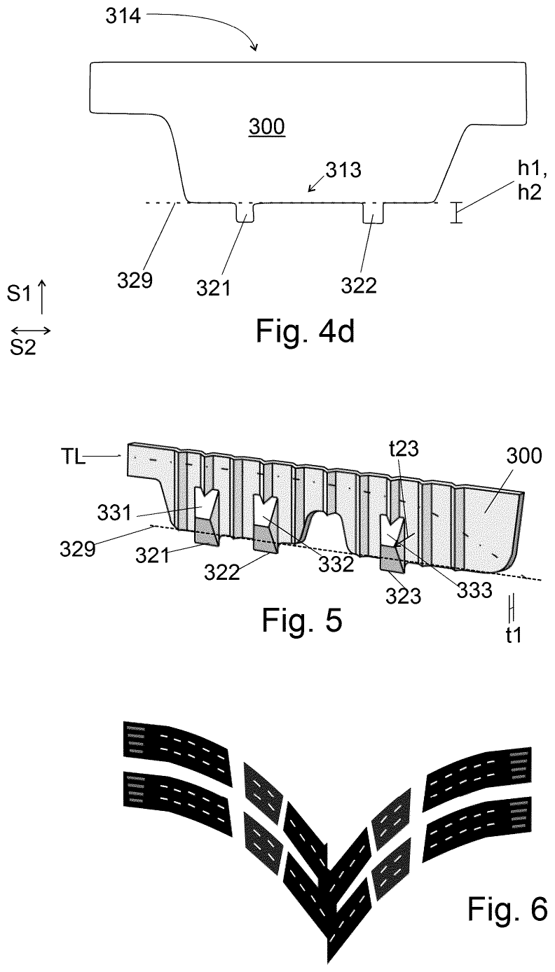

In an embodiment, the first sipe 500 is delimited by a first sipe wall 511, a second sipe wall 512, and a bottom 513 of the first sipe 500. The first sipe 500 comprises the top opening 514. In the embodiment, the top opening 514 of the first sipe 500 has a zig-zag or an undulating pattern. FIGS. 4a and 4b show examples of lamella plates for forming a zig-zag pattern shown in FIG. 7a. FIG. 10a shows an example of a lamella plate for forming an undulating pattern shown in FIG. 7b. FIG. 7c shows an example of a sipe having a stepped pattern. A stepped pattern is also a zig-zag pattern.

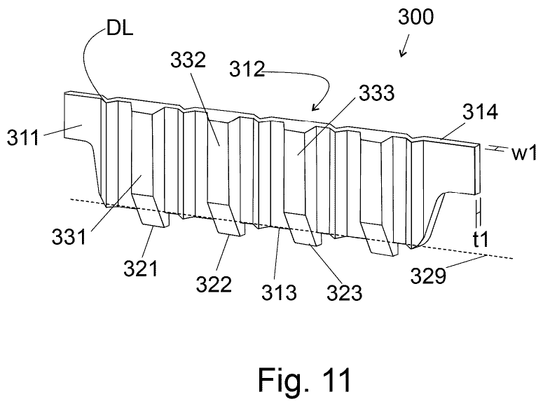

The first sipe wall 511 and the second sipe wall 512 are arranged parallel to each other and define a primary width w1 of the first sipe 500. As readable from the above, a width of the first sipe 500, i.e. a distance between the sipe walls 511, 512, is not constant. However, the primary width w1 of the first sipe 500 is defined as a width of the top opening 514, which may be constant. In case the width of the top opening 514 is not constant, as readable from the embodiment of FIG. 11, the primary width w1 of the first sipe 500 is an average width of the top opening of the first sipe 500, excluding the portions of the top opening that comprise parts of the sipe expansions 531, 532. Reference is made to FIG. 11, even if FIG. 11 shows only a corresponding lamella plate 300.

In the first sipe 500, the bottom 513 of the first sipe 500 is arranged away from the top opening 514 such that the bottom 513 defines a bottom line 529 of the first sipe 500. As shown in FIG. 3a, the bottom line refers to the bottom of the first sipe 500 when the recesses 521, 522 are excluded. A primary depth d1 of the first sipe 500 is defined as a distance between the top opening 514 and the bottom line 529, as shown in FIG. 3a. Thus, the primary depth d1 of the first sipe 500 is arranged between the top opening 514 and the bottom line 529.

The first recess 521 and the second recess 522 intrude to the tread block 210 from the bottom line 529 away from the top opening 514. In this way, the recesses 521, 522 locally deepen the first sipe 500 in a direction that is reverse to the direction S1, as shown in FIG. 3a. Thus, a depth of the first sipe, at the location of a recess 521, 522, is slightly more than the primary depth d1 as defined above.

To provide space for receiving water and/or slush, the first recess 521 is comprised by a first sipe expansion 531. The first sipe expansion 531 extends towards the top opening 514 of the first sipe 500. The first sipe expansion 531 has a secondary first width w21 that exceeds the primary width w1. The secondary first width w21 is measured at a location that is between the bottom line 529 and the top opening 514, as shown in FIG. 3b. The secondary first width w21 is defined as a distance between the sipe walls 511, 512 at that location. The secondary first width w21 is measured in the direction S3, which is perpendicular to a direction S1 of a depth of the first sipe 500 and also is perpendicular to a direction S2 of a length of the first sipe 500.

Likewise, the second recess 522 is comprised by a second sipe expansion 532, the second sipe expansion 532 extending towards the top opening 514 of the first sipe 500 and having a secondary second width w22 as measured at a location that is between the bottom line 529 and the top opening 514. Also the secondary second width w22 exceeds the primary width w1. The secondary second width w22 is measured in the direction S3, which is perpendicular to a direction S1 of a depth of the first sipe 500 and also is perpendicular to a direction S2 of a length of the first sipe 500.

A length l21 of the first recess 521, measured in the direction S2 of a length of the first sipe 500, is preferably 0.5 mm to 10 mm; more preferably 1 to 8 mm or 1 to 5 mm. Reference is made to FIG. 3a. Likewise, length of the second recess 522, measured in the direction S2 of a length of the first sipe 500, is preferably 0.5 mm to 10 mm; more preferably 1 to 8 mm or 1 to 5 mm.

A length of the first sipe expansion 531, measured in the direction S2 of a length of the first sipe 500, is preferably 0.5 mm to 10 mm; more preferably 1 to 8 mm or 1 to 5 mm. Likewise, length of the second sipe expansion 532, measured in the direction S2 of a length of the first sipe 500, is preferably 0.5 mm to 10 mm; more preferably 1 to 8 mm or 1 to 5 mm.

What has been said and will be said about the lengths of the first and second recesses and the first and second sipe expansions apply mutatis mutandis to other recesses and sipe expansions.

For manufacturing reasons, preferably the length of the first recess 521 is equal to the length of the first sipe expansion 531. Likewise, preferably, the length of the second recess 522 is equal to the length of the second sipe expansion 532. These lengths are best seen from the corresponding lamella plates, e.g. those of FIGS. 4a, 5, 10a and 11.

As detailed in connection with background, the first sipe may be made by using a lamella plate 300. For example, the first sipe shown in FIGS. 3a to 3c may be made by the lamella plate 300 shown in FIG. 4a. However, a distance Δ21 between the recesses 521, 522 in FIG. 3a is exaggerated compared to the lamella plate of FIG. 4.

In this way, the invention relates also to a lamella plate 300. It is noted, however, that typically the whole lamella plate 300 is not inserted into the tread during manufacturing. Instead, during manufacturing, the tread surface is arranged on a level of a top line TL as shown in FIGS. 4a and 4b. Above the top line TP, i.e. between the top line TL and a top edge 314 of the lamella plate 300, the lamella plate 300 may be provided with holes for enabling removal of the lamella plate from the rubber material after curing the rubber material of the tyre or the tread band. To clarify this issue, a primary depth d1 of a first sipe 500 manufacturable by the lamella plate of FIG. 10b is shown in FIG. 10b, provided that the top opening 514 of the sipe 500 would be arranged at the level of the top line TL shown in FIG. 10b. Likewise, the part of the lamella plate 300 of FIG. 10b that remains above the top line TL would not be inserted into the tread.

FIGS. 4a to 4d, 5, 10a, 10b, and 11 show embodiments of a lamella plate 300 for forming a sipe 500 to a tread block 210 of a tread block arrangement 200. The tread block arrangement 200 is suitable for a tyre 100 or for a tread band 150 for a tyre 100.

FIGS. 4a to 4d show various views of an embodiment of a lamella plate 300, FIG. 4a being a perspective view and FIGS. 4b and 4c cross-sectional views, and FIG. 4d a side view.

The directions S1, S2, and S3 are mutually perpendicular. In use, the direction S1 may be substantially parallel to the radial direction SR of the tyre, the radial direction SR being directed away from an axis of rotation. A length of the lamella plate 300 is arranged in the direction S2 and a thickness is arranged the direction S3.

The lamella plate 300 comprises a first surface 311 for forming the first sipe wall 511 of the sipe first 500, a second surface 312 opposite to the first surface 312 for forming the second sipe wall 512 of the first sipe 500, a bottom edge 313 for forming a bottom 513 of the sipe 500, and a top edge 314 opposite the bottom edge 313. A distance between the first surface 311 and the second surface 312 defines a primary thickness t1 of the lamella plate 300. In line with the primary width w1 defined for the first sipe above, the primary thickness t1 of the lamella plate may be the thickness of the lamella plate 300 at a location of the top edge 314. The lamella plate 300 is configured to form the first sipe 500 of which top opening 514 has a zig-zag or an undulating pattern. For this reason, the lamella plate 300 comprises deflection lines DL, shown in FIG. 4a or undulation lines UL shown in FIG. 10a. The deflection lines DL extend in the direction S1 as shown in FIG. 4a. The same applies to the undulation lines UL as shown in FIG. 10a.

Concerning the term “deflection line”, when the top opening 514 of the first sipe (of a new tire) has a deflection, i.e. a bend point, and when the tire wear, this deflection moves towards the axis of rotation, and the trace formed by these deflections form the deflection line DL. Reference is made to FIG. 4a.

Concerning the term “undulation line”, when the top opening 514 of the first sipe (of a new tyre) has curved parts, each curved part defines a point of undulation (of the new tyre) such that an undulation point is the point of the curved part that defines a local maximum deviation of a position of the top opening 514 from a straight line extending between two ends of the top opening 514. At an undulation point, a tangent of the top opening 514 is parallel to the straight line extending between two ends of the top opening 514. When the tire wears, an undulation point defined in this way moves towards the axis of rotation, and the trace formed by these undulation points form the undulation line UL. For example, if the top opening 514 has a sinusoidal shape, the points defining the amplitude of the sinusoidal shape defines points of undulation. I.e., each minimum and each maximum deviation from a straight line devices one undulation point. And, if the sinusoidal shape extends in the radial direction, the undulation lines extend in the radial direction and each undulation line comprises an undulation point. Reference is made to FIGS. 7b and 10a.

As readable from FIGS. 7a and 7b, the deflection lines and the undulation lines may be substantially radial in a tyre. It is furthermore noted that not all undulation lines have expressly been associated with the symbol UL in FIG. 7b.

To form the first and second recesses 521, 522, the bottom edge 313 is provided with a first bulge 321 and a second bulge 322. The first bulge 321 and the second bulge 322 protrude from a bottom line 329, i.e. bottom line 329 of the lamella plate 300, defined by the bottom edge 313. The first bulge 321 and the second bulge 322 protrude away from the top edge 314, i.e. at least in a direction that is reverse to the direction S1 (see FIG. 4a). The bulges 321, 322 may further protrude in the direction S3, i.e. in a direction of thickness of the lamella plate 300. The bottom edge 313 defines the bottom line 329 such that the bottom line 329 corresponds a bottom edge of such a lamella plate, from which the bulges 321, 322 would be removed.

Referring to FIGS. 4a and 4b, the lamella plate 300 comprises a first expanded section 331. The first expanded section 331 comprises the first bulge 321. The first expanded section 331 extends towards the top edge 314. The first expanded section 331 has a secondary first thickness t21 that exceeds the primary thickness t1 of the lamella plate 300. The secondary first thickness t21 is measured at a location that is between the bottom line 329 and the top edge 314, as shown in FIG. 4b. The secondary first thickness t21 is defined as a measure between the second surface 312 (which is opposite the first expanded section 321) and an extremum of the first expanded section 321 on the first side 311. Naturally, the first expanded section 331 may expand also on the second surface 312 of the lamella plate 300.

Likewise, and with reference to FIGS. 4a and 4c, the second bulge 322 is comprised by a second expanded section 332 of the lamella plate 300, the second expanded section 332 extending towards the top edge 314 and having a secondary second thickness t22 as measured at a location that is between the bottom line 329 and the top edge 314, the secondary second thickness t22 exceeding the primary thickness t1 of the lamella plate 300. The secondary second thickness t22 is defined as a measure between the second surface 312 (which is opposite the second expanded section 322) and an extremum of the second expanded section 322 on the first side 311. Naturally, the second expanded section 332 may expand also on the second surface 312 of the lamella plate 300.

What has been said about the length of the first (and/or second) recess 521, 522, measured in the direction S2 of a length of the first sipe 500, applies to a length of the first (and/or second) bulge 321, 322, measured in a direction of a length of the lamella plate 300.

What has been said about the length of the first (and/or second) sipe expansion 531, measured in the direction S2 of a length of the first sipe 500, applies to a length of the first (and/or second) expanded section 331, 332, measured in a direction of a length of the lamella plate 300.

What has been said and will be said about the lengths of the first and second bulges and the first and second expanded sections apply mutatis mutandis to other bulges and expanded sections.

For manufacturing reasons, preferably the length of the first bulge 321 is equal to the length of the first expanded section 331. Likewise, preferably, the length of the second bulge 322 is equal to the length of the second expanded section 332.

The lamella plate of FIGS. 4a to 4d may be usable e.g. at a central area of a tread. In line with this, the top line TL shown in FIG. 4a is substantially straight.

FIG. 5 shows, in a perspective view, another embodiment of a lamella plate 300. That lamella plate 300 may be usable e.g. at a shoulder area of a tread. In line with this, the top line TL shown in FIG. 5 is curved and follows a surface of the tread on a shoulder area. As evidenced by FIG. 5, a lamella plate 300 may further comprise a third expanded section 333 that comprises a third bulge 323.

If the expanded section 331, 332 and/or the sipe expansions 531, 532 do not extend to the top opening 514 of the sipe, as is the case in the embodiments of FIGS. 3a to 3c and 4a to 4d and 5, the top opening of the first sipe 500 in a new (i.e. unworn) tyre has a substantially constant width, as shown also in FIG. 2a. However, the tyre wears in use. When the tread has worn to such an extent that the tread surface is arranged at a level of the bottom line 529 of the first sipe, only the recesses 521, 522 remain visible. Such as situation is shown in FIG. 6. By comparing FIG. 6 with FIG. 2c the function of the recesses becomes clear: they provide additional sipes also for a used tyre. However, as discussed in the section “Summary”, the tyre performance of an unworn or partially worn tyre is also good.

As detailed above, a purpose of the sipe expansions 531, 532 is to provide space for water and/or slush. However, it has been noticed that if the sipe expansions 531, 532 extend all the way up to the top opening 514, as shown by a corresponding lamella plate 300 in FIG. 11, the sipe expansions 531, 532 may be filled too rapidly, and in this way possibly do not function in an optimal manner. Therefore, preferably the sipe expansions 531, 532 do not extend all the way up to the top opening 514.

Therefore and with reference to FIGS. 3b and 3c, in an embodiment, the first sipe expansion 531 and the second sipe expansion 532 only extend towards the top opening 514 so that a top 541 of the first sipe expansion 531 is below the top opening 514 of the first sipe 500 and a top 542 of the second sipe expansion 532 is below the top opening 514 of the first sipe 500. In other words, a top 541 of the first sipe expansion 531 is arranged a distance apart from the top opening 514 and a top 542 of the second sipe expansion 532 is arranged a distance apart from the top opening 514.

Correspondingly, and with reference to FIGS. 4b and 4c, in an embodiment of a lamella plate 300, the first expanded section 331 and the second expanded section only extend from towards the top edge 314 so that a top 341 of the first expanded section 331 is below the top edge 314 of the lamella plate 300 and a top 342 of the second expanded section 332 is below the top edge 314 of the lamella plate 300.

As for a proper location of a top of the sipe expansions 531, 532 and the expanded sections 331, 332, reference is made particularly to FIGS. 3b and 3c. In an embodiment of a tread block arrangement 200, the first sipe 500 has such a shape that a top 541 of the first sipe expansion 531 is arranged at a tertiary first depth d31 from the top opening 514. In the embodiment, the tertiary first depth d31 is 30% to 60% of the primary depth d1 of the first sipe 500. Reference is made to FIGS. 3b and 3c as well as 8a and 8b. In a similar manner, in the embodiment, a top 542 of the second sipe expansion 532 is arranged at a tertiary second depth d32 from the top opening 514. In the embodiment, the tertiary second depth d32 is 30% to 60% of the primary depth d1 of the first sipe 500. Preferably, the tertiary first depth d31 is 35% to 55% of the primary depth d1 of the sipe 500 and the tertiary second depth d32 is 35% to 55% of the primary depth d1 of the first sipe 500. However, as readable from FIG. 11, the expanded sections 331, 332 may extend to the top edge 314 of the lamella plate 300, whereby the sipe expansions 531, 532 may extend to the top opening 514.

This can be seen also from a lamella plate 300 of an embodiment. However, as detailed above, a height of the lamella plate 300 may be significantly higher than a depth of a sipe, because during manufacturing, the top edge 314 of the lamella plate and also a part of the lamella plate 300 that is close to the top edge 314 remain outside of the tread that is manufactured.

Therefore, in an embodiment of a lamella plate 300, a top 341 of the first expanded section 331 of the lamella plate 300 is configured to form a top 541 of a first sipe expansion 531, wherein the top 541 of the first sipe expansion 531 is arranged at a depth of 30% to 60%, preferably 35% to 55%, of a primary depth d1 of the first sipe 500. Moreover, a top 342 of the second expanded section 332 of the lamella plate 300 is configured to form a top 542 of a second sipe expansion 532, wherein the top 542 of the second sipe expansion 532 is arranged at a depth 30% to 60%, preferably 35% to 55%, of a primary depth d1 of the first sipe 500.

In an embodiment, the sipe expansions 531, 532 are arranged at a location of a deflection line DL or an undulation line UL. More specifically, in an embodiment of a tread block arrangement 200, the first sipe expansion 531 is arranged at a location of a deflection line DL or an undulation line UL of the first sipe 500 and the second sipe expansion 532 is arranged at a location of another deflection line DL or another undulation line UL of the first sipe 500. Likewise, in an embodiment of a lamella plate 300, the first expanded section 331 is arranged at a location of a deflection line DL or an undulation line UL of the lamella plate 300 and the second expanded section 332 is arranged at a location of another deflection line DL or another undulation line UL of the lamella plate 300. Reference is made to FIGS. 7a and 7b.

To clarify, FIGS. 7a and 7c show in their upper parts, a first sipe 500 as seen from top, i.e. a top opening 514 of the first sipe. As clearly seen, the top opening 514 of the first sipe 500 has five deflection points, which, when extending in the direction S1, form deflection lines DL, two of which have been indicated by the reference letters DL. In addition, FIGS. 7a and 7c show in their lower parts, the first sipe 500 as seen from a side, which shows how the recesses 521, 522 are arranged at the locations of the deflection lines DL. Moreover, because the recesses 521, 522 are comprised by the sipe expansion 531, 532, FIGS. 7a and 7c show how sipe expansions 531, 532 are arranged at locations of a deflection lines DL.

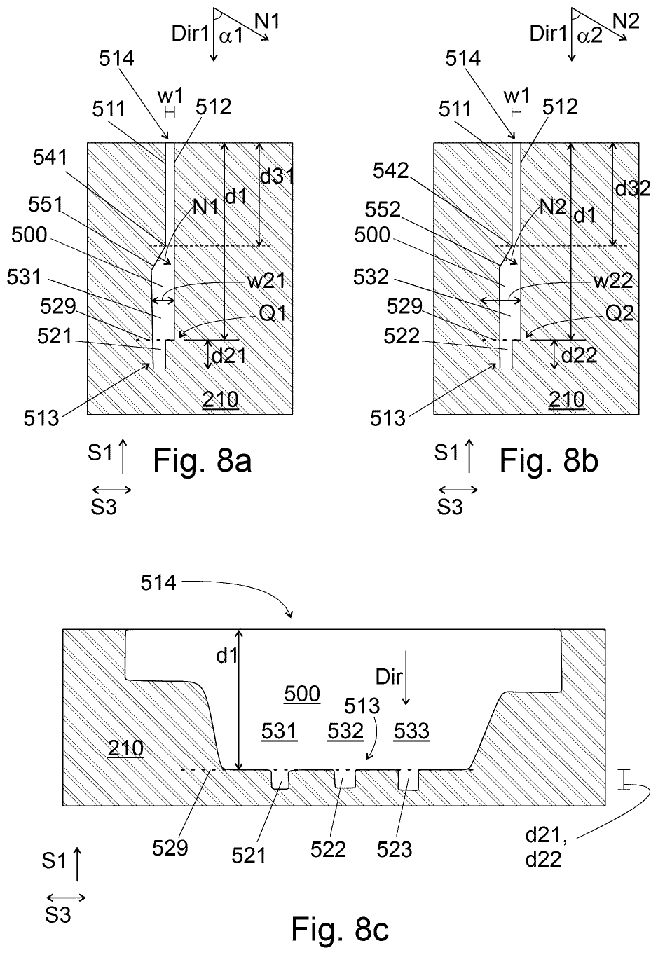

FIG. 7b shows the same matter, when first sipe has an undulating shape. In the upper part of FIG. 7b, the sipe expansions 531, 532 are shown by grey colour to show two embodiments: one in which the sipe expansions 531, 532 do extend to the top opening 514, and another in which the sipe expansions 531, 532 do not extend to the top opening 514, as readable e.g. from FIGS. 8a to 8c in conjunction with FIGS. 10a and 10b.

However, as depicted in FIG. 11, in an embodiment, expanded sections 331, 332 are not arranged at a location of a deflection line DL or an undulation line UL. Correspondingly, in an embodiment of a sipe 500, the sipe expansions 531, 532 are not arranged at a location of a deflection line DL or an undulation line UL. This may be beneficial in terms of manufacturability.

Concerning suitable measures for the bulges 321, 322 and/or the recesses 521, 522, reference is made to FIGS. 3b, 3c, 4b, and 4c. The first recess 521 intrudes the tread block 210 from the bottom line 529 by a secondary first depth d21 of the first recess 521. In a preferable embodiment, the secondary first depth d21 is 0.5 mm to 2.0 mm. Preferably, the second recess 522 is sized in a similar manner. Therefore, in an embodiment, the second recess 522 intrudes the tread block 210 from the bottom line 529 by a secondary second depth d22 of the second recess 522, the secondary second depth d22 being 0.5 mm to 2.0 mm. Even if these preferable depths d21, d22 are shown only in some contexts, they are preferable also in other contexts.

A length l21 of the first recess 521 is substantially less than a length of the sipe 500. In a preferable embodiment, a length l21 of the first recess 521 is 1 mm to 5 mm. Likewise in a preferable embodiment, a length l22 of the second recess 522 is 1 mm to 5 mm.

Notably, also other preferable values are disclosed in this description. These measures apply particularly in combination with the secondary first depth d21 and the secondary second depth d22 detailed above. These lengths l21, l22 are defined in the same direction S2 as a length of the first sipe 500. Reference is made to FIG. 3a.

A distance Δ21 between the first recess 521 and the second recess 522 is, in an embodiment, at least 2 mm, such as 2 mm to 8 mm, preferably 2 mm to 4 mm. Reference is made to FIG. 3a. The distance Δ21 is also defined in the same direction S2 as a length of the first sipe 500. Even if the measures l21, l22, and Δ21 are shown only in FIG. 3a, they are applicable also in other embodiments.

It has been found that a thickness of the tread block 210 that has the sipe 500 affects a proper value of the secondary first depth d21 and the secondary second depth d22. In view of what has been said above, in an embodiment, the secondary first depth d21 is 5% to 20% of a thickness of the tread block that comprises the sipe having the first recess. Likewise, in an embodiment, the secondary second depth d22 is 5% to 20% of a thickness of the tread block that comprises the sipe having the first recess.

Moreover, to maintain sufficient rigidity, preferably, the depth d1 of first sipe 500 is less than a thickness of the tread block 210 comprising the first sipe 500. Thus, a certain thickness of the tread block material is arranged at the bottom of the sipe to ensure sufficient rigidity. Preferably, the depth d1 of first sipe 500 is 0.5 mm to 5 mm less than a thickness of the tread block 210 comprising the first sipe 500. Even more preferably, the depth d1 of first sipe 500 is 1 mm to 2.5 mm less than a thickness of the tread block 210 comprising the first sipe 500.

In an embodiment, a total length of the recesses including the first recess 521 and the second recess 522 and all other recesses of the sipe 500 is 20% to 40% of a length between a first extremum E1 and a second extremum E2 of an intersection of the bottom 513 and the bottom line 529. The extremums E1 and E2 are shown in FIG. 3a. Notably, in the embodiment of FIG. 3a, the total length of the recesses including the first recess 521 and the second recess 522 is less than 20% of the length between the first extremum E1 and the second extremum E2. However, in the sipes 500 manufacturable e.g. by the labella plate 300 of the embodiment of FIG. 11, FIG. 10a, FIG. 5, or FIG. 4a, the ratio is within the preferable limit 20% to 40%. For example, a ratio l21/(Δ21+l21) may be in the range 20% to 40%. In other words, in an embodiment, a ratio (Δ21/l21) of the distance 421 between the first recess 521 and the second recess 522 to the length l21 of the first recess 521 is 1.5 to 4.

These measures have been found to sufficiently improve wet traction and handling of a worn tyre, yet not affecting properties of a new tyre.

Likewise, in the lamella plate 300, the first bulge 321 protrudes from the bottom line 329 by a first height h1 of the first bulge 321. As detailed above, the first bulge 321 protrudes from the bottom line 329 away from the 314 top edge 314 by the first height h1. In an embodiment, the first height h1 of the first bulge 321 is 0.5 mm to 2.0 mm. Moreover, in the lamella plate 300, the second bulge 322 protrudes from the bottom line 329 by a second height h2 of the second bulge 322. As detailed above, the second bulge 322 protrudes from the bottom line 329 away from the top edge 314 by the second height h2. In an embodiment, the second height h2 of the second bulge 321 is 0.5 mm to 2.0 mm. What has been said about the lengths l21, l22 of the first recess 521 and the second recess 522 apply to the lengths of the first and second bulges 321, 322. What has been said about the distance Δ21 between the first recess 521 and the second recess 522 applies to a distance between the first and second bulges 321, 322.

To improve the capability of receiving water and/or slush of the first sipe 500 and in this way improving the wet traction and handling, the secondary widths w21, w22 of the first sipe exceed the primary width w1, as discussed above. However, to sufficiently increase the capability of receiving water and/or slush, the secondary widths w21, w22 should exceed the primary width w1 by a sufficient degree. As for a sufficient degree, in an embodiment the secondary first width w21 of the first sipe expansion 531 of the first sipe 500 exceeds the primary width w1 of the first sipe 500 by at least 50%, and the secondary second width w22 of the second sipe expansion 532 of the first sipe 500 exceeds the primary width w1 of the first sipe 500 by at least 50%. However, for manufacturing reasons, the first width w21 and the second width w22 may be, e.g., at most 4 mm. Preferably, the secondary first width w21 of the first sipe expansion 531 of the first sipe 500 exceeds the primary width w1 of the first sipe 500 by at least 100% or by at least 150%, and the secondary second width w22 of the second sipe expansion 532 of the first sipe 500 exceeds the primary width w1 of the first sipe 500 by at least 100% or by at least 150%. The secondary first width w21 of the first sipe expansion 531 of the first sipe 500 may exceed the primary width w1 of the first sipe 500 by 50%-400% or by 100%-400% or by 150%-300%, and the secondary second width w22 of the second sipe expansion 532 of the first sipe 500 may exceed the primary width w1 of the first sipe 500 by 50%-400% or by 100%-400% or by 150%-300%.

Likewise, in an embodiment of a lamella plate 300, the secondary first thickness t21 of the first expanded section 331 of the lamella plate 300 exceeds the primary thickness t1 of the lamella plate 300 by at least 50%, by at least 100%, by 50% to 400%, by 100% to 400%, or by 150%-300%. Moreover, the secondary second thickness t22 of the second expanded section 332 of the lamella plate 300 exceeds the primary thickness t1 of the lamella plate 300 by at least 50%, by at least 100%, by 50% to 400%, by 100% to 400%, or by 150%-300%.

The inventors have also found that in certain embodiments it may be hard to remove the lamella plate 300 from the cured tread block arrangement without breaking the rubber material of the tread block 210. This is because, in some cases, the expanded sections 331, 332 may resist removal of the lamella plate 300 from the tread block 210, and, if removed with excessive force, the rubber material will break.

The inventors have also found that the resistance for removal can be diminished by making the top surfaces of the expanded sections 331, 332 of the lamella plate 300 inclined as shown in FIGS. 4a, 4b, 4c, 5, 8a, 8b, and 10b. Moreover, in case the expanded sections 331, 332 extend all the way to the top edge 314, as in FIG. 11, the removal of the lamella plate 300 is not hindered by the expanded sections 331, 332.

Referring to FIGS. 4b and 4c, in an embodiment of the lamella plate 300, a top surface 351 of the first expanded section 331 is inclined in such a way that a normal N3 of the top surface 351 of the first expanded section 331, i.e. a third normal N3, forms an angle α3, i.e. a third angle α3, with a second direction Dir2 that is directed from the bottom edge 313 of the lamella plate 300 to the top edge 314 of the lamella plate 300. In use of the plate 300, the direction Dir2 will be parallel to the direction S1 of the sipe 500. In the embodiment, the third angle α3 is 20 to 70 degrees, preferably 30 to 60 degrees. Likewise, in the embodiment, a top surface 352 of the second expanded section 332 is inclined in such a way that a normal N4 of the top surface 352 of the second expanded section 332, i.e. a fourth normal N4, forms an angle α4, i.e. a fourth angle α4 with the second direction Dir2. In the embodiment, the fourth angle α4 is 20 to 70 degrees, preferably 30 to 60 degrees. The third and fourth angles α3 and α4 are shown in FIGS. 4b and 4c, respectively. For clarity, the direction (vectors) that define the angles α3 and α4 are shown also in another location of the figures. As conventional, the direction of the third normal N3 is directed away from the lamella plate 300 (and not into it). The direction of the fourth normal N4 is directed away from the lamella plate 300 (and not into it).

The inclination of the top surfaces 351, 352 shows in a corresponding matter in the first sipe 500. Referring to FIGS. 3b and 3b in an embodiment of the tread block arrangement 200, the first sipe 500 defines a top surface 551 of the first sipe expansion 531 and a top surface 552 of the second sipe expansion 532. In an embodiment, the top surface 551 of the first sipe expansion 531 is inclined in such a way that a normal N1 of the top surface 551 of the first sipe expansion 531, i.e. a first normal N1, forms an angle α1, i.e. a first angle α1, with a first direction Dir1 that is directed from the top opening 514 to the bottom 513 of the first sipe 500. In the embodiment, the first angle α1 is preferably 20 to 70 degrees, more preferably 30 to 60 degrees. As the first normal N1 is a normal of a surface formed by the tread block 210, the first normal N1 is directed towards the sipe 500, i.e. it is not directed into the tread block 210. Reference in made to FIG. 3b. The direction Dir1 is reverse to the direction S1 as shown in FIGS. 3b and 3c.

In a corresponding manner, in the embodiment, a top surface 552 of the second sipe expansion 532 is inclined in such a way that a normal N2 of the top surface 552 of the second sipe expansion 532, i.e. a second normal N2, forms an angle α2, i.e. a second angle α2, with the first direction Dir1, which is directed from the top opening 514 to the bottom 513 of the first sipe 500. As the second normal N2 is a normal of a surface formed by the tread block 210, the second normal N2 is directed towards the sipe 500, i.e. it is not directed into the tread block 210. Reference in made to FIG. 3c. In the embodiment, the second angle α2 is preferably 20 to 70 degrees, more preferably 30 to 60 degrees.

The inventors have also realized that the removal of the lamella plate from the cured rubber material is easier, if each one of the expanded sections (first expanded section 331, second expanded section 332, third expanded section 333) only expands on one side of the lamella plate 300. This furthermore make the manufacture of the lamella plate 300 easier, as an expanded section can be attached on only one side of a body of for the lamella plate 300. Such embodiments are shown in FIGS. 4a, 4b, 4c, 5, 7b, 9b, 10a, and 11. Thus, in an embodiment, each one of the expanded sections (first expanded section 331, second expanded section 332, third expanded section 333) only expand on one side of the lamella plate 300. To this end, there are at least two options. As a first option, it is possible that the first expanded section 331 only expands on a first side of the lamella plate 300 and the second expanded section 332 only expands on a second, opposite, side of the lamella plate 300 (not shown in any of the figures). However, in a preferable embodiment, each one of the expanded sections (first expanded section 331, second expanded section 332, third expanded section 333) only expand on one side of the lamella plate 300 so that all the expanded sections expand on a first side of the lamella plate 300 (see FIGS. 4a, 4b, 4c, 5, 7b, 9b, 10a, and 11). This is preferable at least from the point of view of manufacturing the lamella plate 300. Moreover, this adds more design freedom to the designer for designing the tread block arrangement and the sipes therein.

Likewise, in an embodiment, each one of the sipe expansions (first sipe expansion 531, second sipe expansion 532, third sipe expansion 533) only expands on one side of the first sipe 500. More preferably, each one of the sipe expansions (first sipe expansion 531, second sipe expansion 532, third sipe expansion 533) only expands on one side of the first sipe 500 so that all the sipe expansions only expand on a first side of the first sipe 500.

When the lamella plate 300 is configured to form a first sipe 500 of which top opening 514 has a zig-zag or an undulating pattern, the lamella plate 300 comprises deflection lines DL or undulation lines UL, as detailed above. Moreover, if, in such a case, the first expanded section 331 only expands on one side of the lamella plate 300, the most preferably length of the first expanded section 331 depends on how the first expanded section 331 is arranged relative to an undulation line or a deflection line. What will be said using the first expanded section 331 as an example, applies mutatis mutandis to a length of other expanded sections (such as 332, 333).

Referring first to FIGS. 7b, 9b, 10a, when the first expanded section 331 is arranged relative to an undulation line UL or a deflection line DL such that
the first expanded section 331 only expands on a first side of the lamella plate 300,
the first expanded section 331 is arranged at a location of an undulation line UL or a deflection line of the lamella plate 300 such that
a second side of the of the lamella plate 300, which is opposite the first side of the lamella plate 300, comprises a convex part opposite the first expanded section 331,
   a length of the first expanded section 331 (as measured in the longitudinal direction S2 defined above) is preferably 0.5 mm to 5 mm, more preferably 1 mm to 3 mm. This is because in such a case, the first expanded section 331 may be arranged at a location of the undulation line UL or the deflection line DL of the lamella plate 300 on a concave side of the lamella plate 300 at the location of the undulation line UL or the deflection line. Moreover, even if the length of the first expanded section 331 is, in such a case, relatively short, the concave shape of the first side of the lamella plate 300 forms more contact area for the first expanded section 331 and a body of the lamella plate 300 to ensure sturdy joining of the first expanded section 331 to the body of the lamella plate 300. Moreover, because of a length of the undulation lines UL or the deflection lines DL, in such a case, there might not be sufficient space for a longer first expanded section 331. In case there is sufficient space, the length l21 may be 1 to 5 mm in this case, too.

However, referring next to FIGS. 4a, 5, and 11, when the first expanded section 331 is arranged relative to an undulation line UL or a deflection line DL such that (A and B; or A and C)
[A] the first expanded section 331 only expands on a first side of the lamella plate 300, AND
[B] the first expanded section 331 is arranged at a location of an undulation line UL or a deflection line of the lamella plate 300 such that a second side of the of the lamella plate 300, which is opposite the first side of the lamella plate 300, comprises a concave part opposite the first expanded section 331 (see FIGS. 4a and 5), or
[C] the first expanded section 331 is arranged between locations of undulation lines UL or deflection lines DL (see FIG. 11)
   a length of the first expanded section 331 (as measured in the longitudinal direction S2 defined above) is preferably 1 mm to 10 mm, more preferably 2 mm to 8 mm or 1 mm to 5 mm, most preferably 3 to 5 mm. This is because in such a case, the first expanded section 331 does not gain support from a concave part of the first side of the lamella plate 300, and reliable fixing of the first expanded section may require a longer first expanded section. However, this naturally depends on the manufacturing method of the lamella plate 300. Moulding or 3D printing techniques may provide sufficient sturdiness also for a shorter first expanded section 331. However, forming the lamella plate by fixing a first expanded section 331 to a body of a lamella plate may require a longer expanded section as discussed above.

What has been said about the length of the first expanded section 331 applies equally to the lengths of other expanded sections (332, 333). What has been said about the length of the first expanded section 331 and other expanded sections affect a preferable length of the first sipe expansion 531 as well as second and third sipe expansions 532, 533. Moreover, preferably, the length of the first (second, third) recess 521, 522, 532 is equal to the length of the first (second, third) sipe expansion 531, 532, 533.

Referring to FIGS. 5, 10a, and 11, an embodiment of a lamella plate 300 comprises a third bulge 323. More precisely in an embodiment of a lamella plate, the bottom edge 313 is provided with the first bulge 321, the second bulge 322, and a third bulge 323. The first bulge 321, the second bulge 322 and the third bulge 323 protrude from the bottom line 329. What has been said about the first and second bulges 321, 322 and the first and second expanded sections 331, 332 applies. In addition, the third bulge 323 is comprised by a third expanded section 333 of the lamella plate 300. The third expanded section 333 extends towards the top edge 314. The third expanded section 333 has a secondary third thickness t23. The secondary third thickness t23 is shown in FIG. 5 and measured as a measure between the second surface 312 (which is opposite the third expanded section 323) and an extremum of the third expanded section 323; i.e. in a similar manner as shown in FIGS. 4b and 4c for the secondary first and secondary second thicknesses. Moreover, the secondary third thickness t23 is measured at a location that is between the bottom line 329 and the top edge 314. In addition, the secondary third thickness t22 exceeds the primary thickness t1 of the lamella plate 300.

This applies mutatis mutandis to the first sipe 500. Thus, in an embodiment, the bottom 513 of the first sipe 500 is provided with the first recess 521, the second recess 522, and a third recess 523 (see, e.g. FIG. 8c). What has been said concerning the first recess 521 and the second recess 522 applies. Also the third recess 523 intrudes the tread block 210 from the bottom line 529 away from the top opening 514. Moreover, the third recess 523 is comprised by a third sipe expansion 533, the third sipe expansion 533 extending towards the top opening 514 of the first sipe 500 and having a secondary third width exceeding the primary width w1. The secondary third width is measured at a location that is between the bottom line 529 and the top opening 514. What has been said about a depth d21 and a length l21 of the first recess 521 applies to the third recess 523.

As shown in FIGS. 4a and 5, the expanded sections 331, 332, 333 of the lamella plate may have a prismatic shape. However, as shown in FIG. 10a, the expanded sections 331, 332, 333 of the lamella plate 300 may have a circular cross-section, the cross-section being defined on a plane that has a normal in a direction S1 that is directed from the bottom edge 313 to the top edge 314.

The top surface of the first expanded section 331 in FIG. 10a is not inclined. However, as detailed above, preferably the top surface is inclined. FIG. 10b shows a cross section of such a lamella plate 300 that is otherwise identical to that of FIG. 10a, but the top surface 351 of the first expanded section 331 is inclined. In line with FIG. 4b, the third normal N3 of the top surface 351 has also been indicated. What has been said about the definition and magnitude of the third angle α3 applies.

The embodiment of FIG. 10a or FIG. 10b may be beneficial for reasons of manufacturing the lamella plate 300 and/or for upgrading an existing mould for making a tyre. To improve the properties of the tyre, an existing lamella plate can be provided with pieces of a circular wire cut to desired length. The pieces of cut wire can be attached to the existing lamella plate so that the pieces of cut wire will form the expanded sections 331, 332, 333 of the lamella plate 300 as shown in FIG. 10a. Such pieces may be applied in particular to an undulating sipe. Moreover, the first expanded section 331 may be arranged at a location of an undulation line UL of the lamella plate 300 on a concave side of the lamella plate 300 at the location of the undulation line UL. Likewise, the second expanded section 332 may be arranged at a location of another undulation line UL of the lamella plate 300 on a concave side of the lamella plate 300 at the location of the other undulation line UL.

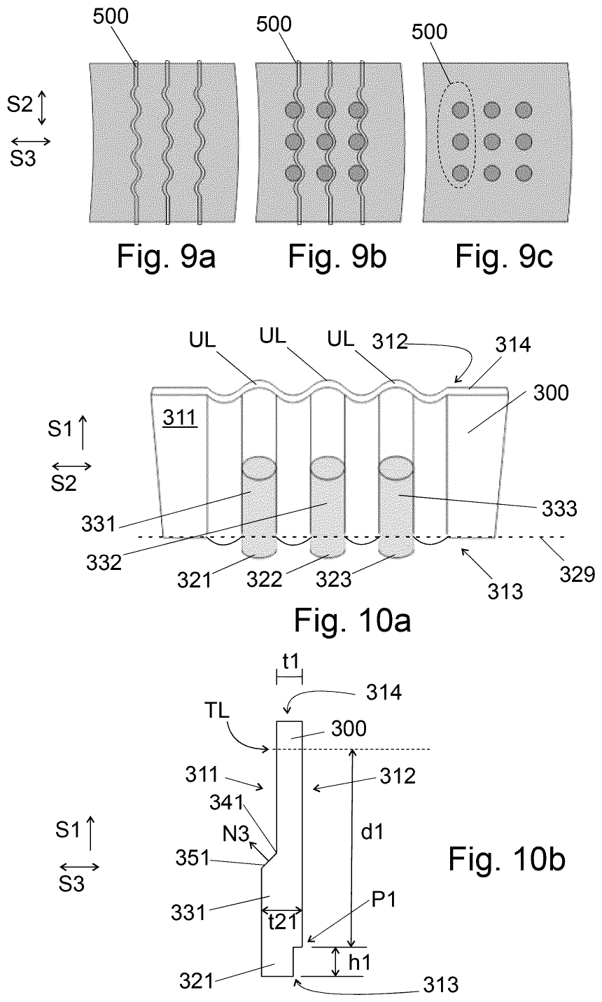

The shape of the top opening 514 of the sipe formed by such a lamella plate depends on the degree of wear of the tyre. Referring to FIGS. 9a to 9c, provided that a first sipe 500 is formed by using the lamella plate 300 of FIG. 10a, the first sipe of a new tyre resembles that of FIG. 9a. When the tyre wears such that the top surface 551 of the first sipe expansion 531 is worn away, the top opening of the sipe of the worn tyre resembles that of FIG. 9b. However, when the tyre further wears such that the tread surface reaches the bottom line 529 of the first sipe 500, the worn tyre resembles that of FIG. 9c.

The first sipe 500 formed by a lamella plate 300 that is otherwise identical to that of FIG. 10a, but the top surface 351 of the first expanded section 331 is inclined as in FIG. 10b, is depicted in FIGS. 8a to 8c. The reference numbers shown in FIGS. 8a to 8c have been explained above in the context of the embodiment shown in FIGS. 3a to 3c. What has been said in that context applies mutatis mutandis in the context of FIGS. 8a to 8c.

As indicated in the context of FIGS. 10a and 10b, the lamella plate 300 may be manufactured by fixing thereto portions of tubular elements, such as cut wires. However, as readable from FIGS. 4a and 5, also another embodiment of the lamella plate 300 may be manufactured e.g. by fixing to a plate-like lamella plate parts for forming the expanded sections 331, 332, 333. This provides for an easy and cost-effective way of producing such a lamella plate 300. As shown in FIGS. 4b, 4c, and 11, the expanded sections 331, 332 may extend also directly beneath a main part of the lamella plate 30.

In some cases the part that is attached to the original lamella plate (i.e. The one without the expanded sections 331, 332, 333) to form the expanded section of the lamella plate 300, does not have a recess for receiving a part of the original lamella plate. In such cases, when the part is attached to a first side of the original lamella plate, the resulting lamella plate 300 will have on the second side a step at the location of the bottom line 329. Likewise, that embodiment of the lamella plate 300 comprises on the second side 312 a first step P1 that is arranged at the location of a crossing of the bottom line 329 and the first expanded section 331. Reference is made to FIG. 10b. Moreover, that embodiment of the lamella plate 300 comprises on the second side 312 a second step (not shown) that is arranged at the location of a crossing of the bottom line 329 and the second expanded section 332. Preferably, a width of the first step P1 equals the primary thickness t1. Preferably, a width of the second step equals the primary thickness t1. The widths of the steps are measured in the direction S3, in which also the direction of the primary thickness t1 is defined (see FIG. 10a. The second step would be visible in exactly the same manner as the first step P1 of FIG. 10b, in a figure showing a cross section of the second expanded section 332 instead of the cross section of first expanded section 331 shown in FIG. 10b. Reference is made also to FIGS. 8a and 8b.

Likewise, in an embodiment of the tread block arrangement 200, the second wall 512 of the first sipe 500 comprises first footstep Q1 that is arranged at the location of a crossing of the bottom line 529 of the first sipe 500 and the first sipe expansion 531. Reference is made to FIG. 8a. In a similar manner, the second wall 512 of the first sipe 500 comprises a second footstep Q2 that is arranged at the location of a crossing of the bottom line 529 of the first sipe 500 and the second sipe expansion 532. Reference is made to FIG. 8b. Preferably, a width of the first footstep Q1 equals the primary width w1. Preferably, a width of the second footstep Q2 equals the primary width w1. The widths of the footsteps are measured in the direction S3, in which also the primary width w1 is defined (see FIGS. 3b and 3c).

Referring to FIG. 1a, an embodiment of a tyre 100 comprises a tread block arrangement 200 having the tread block 210 having the first sipe 500 as disclosed above. A tread block may comprise multiple sipes each of which comprise the recesses 521, 522 (and optionally 523) as discussed above. A tread block arrangement may comprise multiple tread blocks, each comprising multiple sipes, each of which sipes comprise the recesses 521, 522 (and optionally 523) as discussed above.

The tyre 100 is preferably a pneumatic tyre 100, such as a pneumatic tyre for a motor vehicle, in particular to a pneumatic tyre for a motor vehicle weighing from 750 kg to 5000 kg. The tyre has a tread 110 comprising the tread block arrangement 200 as disclosed above.

The following Examples elucidate aspects of the disclosure:

1. A tread block arrangement (200) suitable for a tyre (100) or for a tread band (150) for a tyre (100), the tread block arrangement (200) comprising:
a tread block (210) comprising a first sipe wall (511), a second sipe wall (512), and a bottom (513) delimiting a first sipe (500) wherein
the first sipe (500) comprises a top opening (514),
the top opening (514) of the first sipe (500) has a zig-zag or an undulating pattern,
the first sipe wall (511) and the second sipe wall (512) are arranged parallel to each other and define a primary width (w1) of the first sipe (500), the primary width (w1) of the first sipe (500) being a width of the top opening (514), and
the bottom (513) defines a bottom line (529) of the first sipe, wherein a primary depth (d1) of the first sipe (500) is arranged between the top opening (514) and the bottom line (529), wherein
the bottom (513) of the first sipe (500) is provided with at least a first recess (521) and a second recess (522), the first recess (521) and the second recess (522) intruding the tread block (210) from the bottom line (529) away from the top opening (514), wherein
the first recess (521) is comprised by a first sipe expansion (531), the first sipe expansion (531) extending towards the top opening (514) of the first sipe (500) and having a secondary first width (w21) as measured between the first sipe wall (511) and the second sipe wall (512) at a location between the bottom line (529) and the top opening (514), the secondary first width (w21) exceeding the primary width (w1), and
the second recess (522) is comprised by a second sipe expansion (532), the second sipe expansion (532) extending towards the top opening (514) of the first sipe (500) and having a secondary second width (w22) as measured between the first sipe wall (511) and the second sipe wall (512) at a location between the bottom line (529) and the top opening (514), the secondary second width (w22) exceeding the primary width (w1).

2. The tread block arrangement (200) of the Example 1, wherein
the first recess (521) intrudes the tread block (210) from the bottom line (529) by a secondary first depth (d21) of the first recess (521), the secondary first depth (d21) being 0.5 mm to 2.0 mm and
the second recess (522) intrudes the tread block (210) from the bottom line (529) by a secondary second depth (d22) of the second recess (522), the secondary second depth (d22) being 0.5 mm to 2.0 mm.

3. The tread block arrangement (200) of Example 1 or 2, wherein
the secondary first width (w21) of the first sipe expansion (531) of the first sipe (500) exceeds the primary width (w1) of the first sipe (500) by at least 50%, e.g., the secondary first width (w21) of the first sipe expansion (531) of the first sipe (500) exceeds the primary width (w1) of the first sipe (500) by 50 to 400%; and
the secondary second width (w22) of the second sipe expansion (532) of the first sipe (500) exceeds the primary width (w1) of the first sipe (500) by at least 50%, e.g., the secondary second width (w22) of the second sipe expansion (532) of the first sipe (500) exceeds the primary width (w1) of the first sipe (500) by 50% to 400%.

4. The tread block arrangement of any of the Examples 1 to 3, wherein
a length (l21) of the first recess (521) is 1 mm to 5 mm and
a length (l22) of the second recess (522) is 1 mm to 5 mm.

5. The tread block arrangement of any of the Examples 1 to 4, wherein
a distance (Δ21) between the first recess (521) and the second recess (522) is at least 2 mm, such as 2 mm to 8 mm and/or
a ratio (Δ21/l21) of a distance (Δ21) between the first recess (521) and the second recess (522) to a length (l21) of the first recess (521) is 1.5 to 4.

6. The tread block arrangement (200) of any of the Examples 1 to 5, wherein
a top surface (551) of the first sipe expansion (531) is inclined in such a way that a first normal (N1) of the top surface (551) of the first sipe expansion (531) forms a first angle (α1) of 20 to 70 degrees with a first direction (Dir1) that is directed from the top opening (514) to the bottom (513) of the first sipe (500) and
a top surface (552) of the second sipe expansion (532) is inclined in such a way that a second normal (N2) of the top surface (552) of the second sipe expansion (532) forms a second angle (α2) of 20 to 70 degrees with the first direction (Dir1).

7. The tread block arrangement (200) of any of the Examples 1 to 6, wherein
a top (541) of the first sipe expansion (531) is arranged at a tertiary first depth (d31) from the top opening (514), the tertiary first depth (d31) being 30% to 60% of the primary depth (d1) of the first sipe (500) and
a top (542) of the second sipe expansion (532) is arranged at a tertiary second depth (d32) from the top opening (514), the tertiary second depth (d32) being 30% to 60% of the primary depth (d1) of the first sipe (500).

8. A tyre having (100) a tread (110) comprising the tread block arrangement (200) of any of the Examples 1 to 7.

9. A lamella plate (300) for forming a first sipe (500) to a tread block (210) of a tread block arrangement (200) suitable for a tyre (100) or for a tread band (150) for a tyre (100), the lamella plate (300) comprising:
a first surface (311) for forming a first sipe wall (511) of the first sipe (500),
a second surface (312) opposite to the first surface (312) for forming a second sipe wall (512) of the first sipe (500),
a bottom edge (313) for forming a bottom (513) of the first sipe (500), and
a top edge (314) opposite the bottom edge (313), wherein
a distance between the first surface (311) and the second surface (312) defines a primary thickness (t1) of the lamella plate (300), and
the lamella plate (300) is configured to form a first sipe (500) of which top opening (514) has a zig-zag or an undulating pattern, wherein
the bottom edge (313) is provided with a first bulge (321) and a second bulge (322), the first bulge (321) and the second bulge (322) protruding from a bottom line (329) defined by the bottom edge (313) away from the top edge (314), wherein
the first bulge (321) is comprised by a first expanded section (331) of the lamella plate (300), the first expanded section (331) extending towards the top edge (314) and having a secondary first thickness (t21) as measured at a location between the bottom line (329) and the top edge (314), the secondary first thickness (t21) exceeding the primary thickness (t1) of the lamella plate (300), and
the second bulge (322) is comprised by a second expanded section (332) of the lamella plate (300), the second expanded section (332) extending towards the top edge (314) and having a secondary second thickness (t22) as measured at a location between the bottom line (329) and the top edge (314), the secondary second thickness (t22) exceeding the primary thickness (t1) of the lamella plate (300).

10. The lamella plate (300) of the Example 9, wherein
the first bulge (321) protrudes from the bottom line (329) by a first height (h1) of the first bulge (321), the first height (h1) of the first bulge (321) being 0.5 mm to 2.0 mm and
the second bulge (322) protrudes from the bottom line (329) by a second height (h2) of the second bulge (322), the second height (h2) of the second bulge (322) being 0.5 mm to 2.0 mm.

11. The lamella plate (300) of the Example 9 or 10, wherein
the secondary first thickness (t21) of the first expanded section (331) of the lamella plate (300) exceeds the primary thickness (t1) of the lamella plate (300) by at least 50%, e.g., the secondary first thickness (t21) of the first expanded section (331) of the lamella plate (300) exceeds the primary thickness (t1) of the lamella plate (300) by 50% to 400%, and
the secondary second thickness (t22) of the second expanded section (332) of the lamella plate (300) exceeds the primary thickness (t1) of the lamella plate (300) by at least 50%, e.g., the secondary second thickness (t22) of the second expanded section (332) of the lamella plate (300) exceeds the primary thickness (t1) of the lamella plate (300) by 50% to 400%.

12. The lamella plate (300) of any of the Examples 9 to 11, wherein
a length of the first bulge (321) is 1 mm to 5 mm and
a length of the second bulge (322) is 1 mm to 5 mm.

13. The lamella plate (300) of any of the Examples 9 to 12, wherein
a distance between the first bulge (321) and the second bulge (322) is at least 2 mm, such as 2 mm to 8 mm and/or
a ratio of a distance between the first bulge (321) and the second bulge (322) to a length of the first bulge (321) is 1.5 to 4.

14. The lamella plate (300) of any of the Examples 9 to 13, wherein
a top surface (351) of the first expanded section (331) is inclined in such a way that a third normal (N3) of the top surface (351) of the first expanded section (331) forms a third angle (α3) with a second direction (Dir2) that is directed from the bottom edge (313) to the top edge (314), the third angle (α3) being 20 to 70 degrees, and
a top surface (352) of the second expanded section (332) is inclined in such a way that a fourth normal (N4) of the top surface (352) of the second expanded section (332) forms a fourth angle (α4) with the second direction (Dir2), the fourth angle (α4) being 20 to 70 degrees.

15. The lamella plate (300) of any of the Examples 9 to 14, wherein
a top (341) of the first expanded section (331) is configured to form a top (541) of a first sipe expansion (531), wherein the top (541) of the first sipe expansion (531) is arranged at a depth of 30% to 60% of a primary depth (d1) of the first sipe (500) and
a top (342) of the second expanded section (332) is configured to form a top (542) of a second sipe expansion (532), wherein the top (542) of the second sipe expansion (532) is arranged at a depth of 30% to 60% of a primary depth (d1) of the first sipe (500).

1. A tread block arrangement suitable for a tyre or for a tread band for a tyre, the tread block arrangement comprising:
a tread block comprising a first sipe wall, a second sipe wall, and a bottom delimiting a first sipe, wherein
the first sipe comprises a top opening,
the top opening of the first sipe has a zig-zag or an undulating pattern,
the first sipe wall and the second sipe wall are arranged parallel to each other and define a primary width of the first sipe, the primary width of the first sipe being a width of the top opening,
the bottom defines a bottom line of the first sipe, wherein a primary depth of the first sipe is arranged between the top opening and the bottom line,
the bottom of the first sipe is provided with at least a first recess and a second recess, the first recess and the second recess intruding the tread block from the bottom line away from the top opening,
the first recess is comprised by a first sipe expansion, the first sipe expansion extending towards the top opening of the first sipe and having a secondary first width as measured between the first sipe wall and the second sipe wall at a location between the bottom line and the top opening, the secondary first width exceeding the primary width,
the second recess is comprised by a second sipe expansion, the second sipe expansion extending towards the top opening of the first sipe and having a secondary second width as measured between the first sipe wall and the second sipe wall at a location between the bottom line and the top opening, the secondary second width exceeding the primary width,
a top surface of the first sipe expansion is inclined in such a way that a first normal of the top surface of the first sipe expansion forms a first angle of 20 to 70 degrees with a first direction that is directed from the top opening to the bottom of the first sipe, and
a top surface of the second sipe expansion is inclined in such a way that a second normal of the top surface of the second sipe expansion forms a second angle of 20 to 70 degrees with the first direction.

2. The tread block arrangement of the claim 1, wherein
the first recess intrudes the tread block from the bottom line by a secondary first depth of the first recess, the secondary first depth being 0.5 mm to 2.0 mm and
the second recess intrudes the tread block from the bottom line by a secondary second depth of the second recess, the secondary second depth being 0.5 mm to 2.0 mm.

3. The tread block arrangement of claim 1, wherein
the secondary first width of the first sipe expansion of the first sipe exceeds the primary width of the first sipe by at least 50%, e.g., the secondary first width of the first sipe expansion of the first sipe exceeds the primary width of the first sipe by 50 to 400%; and
the secondary second width of the second sipe expansion of the first sipe exceeds the primary width of the first sipe by at least 50%, e.g., the secondary second width of the second sipe expansion of the first sipe exceeds the primary width of the first sipe by 50% to 400%.

4. The tread block arrangement of the claim 1, wherein
a length of the first recess is 1 mm to 5 mm and
a length of the second recess is 1 mm to 5 mm.

5. The tread block arrangement of the claim 1, wherein
a distance between the first recess and the second recess is at least 2 mm, such as 2 mm to 8 mm.

6. The tread block arrangement of the claim 1, wherein
a ratio of a distance between the first recess and the second recess to a length of the first recess is 1.5 to 4.

7. The tread block arrangement of the claim 1, wherein
a top of the first sipe expansion is arranged at a tertiary first depth from the top opening, the tertiary first depth being 30% to 60% of the primary depth of the first sipe and
a top of the second sipe expansion is arranged at a tertiary second depth from the top opening, the tertiary second depth being 30% to 60% of the primary depth of the first sipe.

8. The tread block arrangement of the claim 1, wherein
the first sipe expansion only expands on one side of the first sipe and
the second sipe expansion only expands on one side of the first sipe; preferably,
the first sipe expansion only expands on a first side of the first sipe and
the second sipe expansion only expands on the first side of the first sipe.

9. A tyre having a tread comprising the tread block arrangement of the claim 1.

10. A lamella plate for forming a first sipe to a tread block of a tread block arrangement suitable for a tyre or for a tread band for a tyre, the lamella plate comprising:
a first surface for forming a first sipe wall of the first sipe,
a second surface opposite to the first surface for forming a second sipe wall of the first sipe,
a bottom edge for forming a bottom of the first sipe, and
a top edge opposite the bottom edge, wherein
a distance between the first surface and the second surface defines a primary thickness of the lamella plate, and
the lamella plate is configured to form a first sipe of which top opening has a zig-zag or an undulating pattern,
the bottom edge is provided with a first bulge and a second bulge, the first bulge and the second bulge protruding from a bottom line defined by the bottom edge away from the top edge,
the first bulge is comprised by a first expanded section of the lamella plate, the first expanded section extending towards the top edge and having a secondary first thickness as measured at a location between the bottom line and the top edge, the secondary first thickness exceeding the primary thickness of the lamella plate,
the second bulge is comprised by a second expanded section of the lamella plate, the second expanded section extending towards the top edge and having a secondary second thickness as measured at a location between the bottom line and the top edge, the secondary second thickness exceeding the primary thickness of the lamella plate,
a top surface of the first expanded section is inclined in such a way that a third normal of the top surface of the first expanded section forms a third angle with a second direction that is directed from the bottom edge to the top edge, the third angle being 20 to 70 degrees, and
a top surface of the second expanded section is inclined in such a way that a fourth normal of the top surface of the second expanded section forms a fourth angle with the second direction, the fourth angle being 20 to 70 degrees.

11. The lamella plate of the claim 10, wherein
the first bulge protrudes from the bottom line by a first height of the first bulge, the first height of the first bulge being 0.5 mm to 2.0 mm and
the second bulge protrudes from the bottom line by a second height of the second bulge, the second height of the second bulge being 0.5 mm to 2.0 mm.

12. The lamella plate of the claim 10, wherein
the secondary first thickness of the first expanded section of the lamella plate exceeds the primary thickness of the lamella plate by at least 50%, e.g., the secondary first thickness of the first expanded section of the lamella plate exceeds the primary thickness of the lamella plate by 50% to 400%, and
the secondary second thickness of the second expanded section of the lamella plate exceeds the primary thickness of the lamella plate by at least 50%, e.g., the secondary second thickness of the second expanded section of the lamella plate exceeds the primary thickness of the lamella plate by 50% to 400%.

13. The lamella plate of the claim 10, wherein
a length of the first bulge is 1 mm to 5 mm and
a length of the second bulge is 1 mm to 5 mm.

14. The lamella plate of the claim 10, wherein
a distance between the first bulge and the second bulge is at least 2 mm, such as 2 mm to 8 mm.

15. The lamella plate of the claim 10, wherein
a ratio of a distance between the first bulge and the second bulge to a length of the first bulge is 1.5 to 4.

16. The lamella plate of the claim 10, wherein
a top of the first expanded section is configured to form a top of a first sipe expansion, wherein the top of the first sipe expansion is arranged at a depth of 30% to 60% of a primary depth of the first sipe and
a top of the second expanded section is configured to form a top of a second sipe expansion, wherein the top of the second sipe expansion is arranged at a depth of 30% to 60% of a primary depth of the first sipe.

17. The lamella plate of the claim 10, wherein
the first expanded section of the lamella plate only expands on one side of the lamella plate and
the second expanded section of the lamella plate only expands on one side of the lamella plate;
preferably
the first expanded section of the lamella plate only expands on a first side of the lamella plate and
the second expanded section of the lamella plate only expands on the first side of the lamella plate.
